(19) United States
(12) Patent Application Publication
(10) Pub. No.: US 2015/0314768 A1
(43) Pub. Date: Nov. 5, 2015

(54) VEHICLE DRIVE AWAY BASED ENGINE CONTROL

(71) Applicant: FORD GLOBAL TECHNOLOGIES, LLC, Dearborn, MI (US)

(72) Inventor: ROBERT WRIGHT, Royal Oak, MI (US)

(73) Assignee: FORD GLOBAL TECHNOLOGIES, LLC, Dearborn, MI (US)

(21) Appl. No.: 14/265,529

(22) Filed: Apr. 30, 2014

(51) Int. Cl. B60W 10/06; B60W 10/18

(52) U.S. Cl. CPC B60W 10/06; B60W 10/182; B60W 2710/06; B60W 2710/18; Y10S 903/902

(57) ABSTRACT

A powertrain for a vehicle may include an engine and at least one controller. The controller may be programmed to, while the engine is off and during a generally constant accelerator pedal input, start the engine in response to an increase in relative acceleration of an object in front of the vehicle greater than a threshold.

### TECHNICAL FIELD

The present application relates to engine stop/start control and vehicle drive away prediction techniques.

### BACKGROUND

Vehicles may be equipped with an engine stop/start feature. This feature shuts down the engine during certain periods of vehicle operation in order to conserve fuel. For example, the auto-stop feature may be engaged when the vehicle is stopped rather than permitting the engine to idle. The engine may be restarted when the driver releases the brake or actuates the accelerator. The auto-stop feature may also be engaged if an electric machine is available to propel the vehicle.

### SUMMARY

In at least one embodiment, a powertrain for a vehicle is provided. The powertrain may include an engine and at least one controller. The controller may be programmed to, while the engine is off and during a generally constant accelerator pedal input, start the engine in response to an increase in relative acceleration of an object in front of the vehicle greater than a threshold.

In at least one embodiment, a powertrain controller is provided. The powertrain controller may include communication channels configured to receive a relative acceleration signal and to provide an engine start/stop command, and control logic. The control logic may be configured to output an engine stop command, while the engine is on and during a generally constant accelerator pedal input, in response to a decrease in relative acceleration of an object in front of a vehicle greater than a threshold.

In at least one embodiment, a method of controlling a hybrid electric vehicle having an engine and an electric machine is provided. The method may include, while operating in a first mode of operation with the engine off and a generally constant accelerator pedal input, starting the engine in response to an increase in relative acceleration of an object in front of the vehicle greater than a threshold.

### BRIEF DESCRIPTION OF THE DRAWINGS

FIG. 1 is a schematic diagram of a hybrid electric vehicle.

FIGS. 2A through 2D are time plots showing an exemplary system response to an object in front of a vehicle.

FIG. 3 is a flowchart illustrating an algorithm for controlling a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

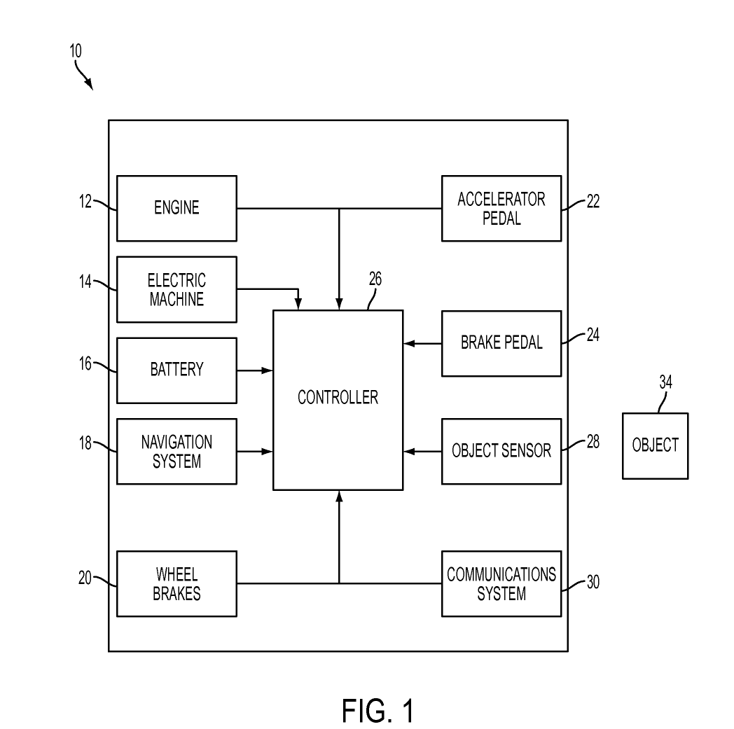

Referring to FIG. 1, a schematic diagram of a vehicle 10 is illustrated. The vehicle 10 includes an engine 12, an electric machine 14, a battery 16, a navigation system 18, at least one wheel brake 20, an accelerator pedal 22, and a brake pedal 24. The vehicle further includes at least one controller 26, an object sensor 28, and a communication system 30. The engine 12, electric machine 14, battery 16, navigation system 18, wheel brake 20, accelerator pedal 22, brake pedal 24, object sensor 28, and communications system 30 are all in communication with or under the control of the controller 26. In at least one embodiment, the navigation system 18 may be an in-vehicle GPS or aGPS system. aGPS, or Assisted GPS, modules utilize cellular communications data to improve the time to fix a location. In another embodiment, the navigation system 16 may comprise a location-enabled mobile device such as a cellular phone or standalone GPS unit. Other configurations are, of course, also possible.

The at least one controller 26 may issue stop commands and start commands to the engine 12 during vehicle operation. The controller 26 may comprise stop/start logic that issues stop commands to shut down the engine 12 and start commands to start the engine 12.

The controller 26 may be further programmed to operate the vehicle in at least two modes. These modes may include an Electric Vehicle (EV) mode and a Hybrid Electric Vehicle (vehicle) mode. In the first mode of operation, EV mode, the engine 12 may be disabled or otherwise prevented from distributing torque to the gear box (not shown) to conserve fuel. The electric machine 14 may act as the sole or primary power source. The engine 12 may be disconnected from the remainder of the vehicle 10.

The battery 16 may transmit stored electrical energy through wiring (not shown) to be used by the electric machine 14. Upon initial vehicle start up, the controller 26 may be programmed to operate the vehicle 10 in EV mode and utilize as much pre-saved battery electric energy as possible prior to the next battery charge event.

The EV mode may have two electric energy consumption modes; a charge-sustaining (CS) mode and a charge-depleting (CD) mode. In the CS mode, the battery 16 state of charge (SOC) may be maintained around a constant SOC level. Due to the battery SOC sustenance requirement, the engine 12 may need to be started and kept on or operational to provide power for vehicle propulsion and battery 16 recharging. The controller 26 may also operate the vehicle 10 in CD mode while the battery SOC level is above a target level. In the CD mode, the battery SOC may have a net decrease during the drive cycle.

These electric energy consumption modes may assist in improving overall vehicle fuel consumption. Furthermore when operating in CD mode, the battery 16 may have sufficient electric energy conservation and its usage will not be constrained by the battery 16 SOC sustenance requirement. As a result, the controller 26 may operate the vehicle 10 in EV mode without requiring engine-on in satisfying demanded drive power in CD mode.

In the second mode of operation, the engine 12 may deliver torque through the gear box (not shown) to propel the vehicle 10. To drive the vehicle with the engine 12, at least a portion of the engine torque may transferred to the electric machine 14, and then from the electric machine 14 through the gearbox. The electric machine 14 may assist the engine 12 by providing additional power to propel the vehicle. This operation mode may be referred to as a “hybrid mode” or an “electric assist mode.”

In any mode of operation, the electric machine 14 may act as a motor and provide a driving force for the vehicle 10. Alternatively, the electric machine 14 may act as a generator and convert kinetic energy from the engine 12 into electric energy to be stored in the battery 16. The electric machine 14 may act as a generator while the engine 12 is providing propulsion power for the vehicle 10, for example. The electric machine 14 may additionally act as a generator during times of regenerative braking in which rotational energy from spinning wheels is converted into electrical energy for storage in the battery 16.

It should be understood that the schematic illustrated in FIG. 1 is merely exemplary and is not intended to be limiting. Other configurations are also contemplated. Some utilize selective engagement of both an engine and a motor to transmit torque through the transmission to propel the vehicle. Others lack a motor and instead exclusively rely on an engine to propel the vehicle that is outfitted with stop/start capabilities.

An accelerator pedal 22 may be used by the driver to provide a demanded torque, power, or drive command to propel the vehicle 10. In general, depressing and releasing the accelerator pedal 22 generates an accelerator pedal position signal that may be interpreted by the controller 26 as a demand for increased power or decreased power, respectively. Based at least upon input from the pedal 22, the controller 26 may command torque from the engine 12 and/or the electric machine 14. The controller 26 may also control the timing of gear shifts within the gearbox.

A brake pedal 24 may be used by the driver to slow down or stop the vehicle 10. In response to depressing the brake pedal 24, the brake booster/master cylinder (not shown) may be activated and fluid pressure sent to the wheel brakes, such as calipers or drum brakes, which in turn apply frictional force to rotors or drums, respectively. The depressing of the brake pedal 24 may be interpreted by the controller 26 as a demand for decreased power. Based at least upon the input from the brake pedal 24, the controller 26 may command an engine shut down to conserve fuel and to slow down the vehicle prior to stopping.

The controller 26 may be programmed with a start-stop algorithm which may selectively start or shut down the engine 12 based on various inputs from, for example, the accelerator pedal 22, brake pedal 24 and object sensor 28. The controller 26 may command an engine start, while the vehicle 10 is operated in EV mode, in response to an accelerator pedal 22 input being greater than a threshold. The controller 26 may also command an engine start in response to the anticipated power requested by the driver, determined by depressing the accelerator pedal 22, exceeding the available electric power that may be provided by the powertrain 12 when operating in EV mode.

The controller 26 may command an engine shut down while the vehicle 10 is stopped or is decelerating to conserve fuel and reduce emissions. The controller 26 may command an engine shutdown, while the powertrain is operated in vehicle mode, in response to a brake pedal 24 input greater than a threshold. The controller 26 may also command an engine start while the powertrain is operated in EV mode in response to the brake pedal 24 being released.

The controller 26 may also receive input from an object sensor 28 and utilize the input to determine whether to start or stop the engine 12, independent of input from the accelerator pedal 22 or brake pedal 24. The object sensor 28 may for example be a front bumper sensor, active cruise sensor, lane change departure sensors, optical camera or on board radar. The object sensor 28 may be configured to work in association with the controller 26 to determine when the vehicle 10 is coming to a stop, idling or an object 34 is within the path of the vehicle 10, and automatically turn off the engine 12.

The controller 26 may receive input from object sensor 28 indicative of a traffic signal, stop sign or object in front of the vehicle 10. Traffic light status may be detected in situations where the traffic light is equipped to broadcast the traffic light status and the emergency vehicle has “captured” the traffic light. The controller 26 may receive input from communications system 30 indicative of the traffic light status or traffic conditions. A determination may be made of whether the vehicle 10 is located in an intersection or traffic congestion. This determination may be made based on GPS data from the navigation system 18. The controller 26 may receive input from navigation system 18 indicative of the vehicle's location in an intersection.

The controller 26 may command an engine start while the vehicle 10 is stopped and operating in EV mode, in response to the relative acceleration of an object forward of the vehicle 10 exceeding a threshold. The object sensor 28 may provide a signal indicative of the relative acceleration of the object 34 forward of the vehicle 10. The relative acceleration may indicate a change in the state of motion of the object 34 forward of the vehicle 10 assuming the vehicle 10 is fixed or stationary. The relative acceleration may be a signed value to indicate whether the object 34 is accelerating away from the vehicle 10 or accelerating towards the vehicle 10. Alternatively, the relative acceleration may indicate if the vehicle 10 is approaching the object 34. The relative acceleration may permit the controller 26 to infer a distance between the vehicle 10 and the object.

Based on an increase of the relative acceleration of an object 34 forward of the vehicle 10, the controller 26 may determine an anticipated amount of power to maintain a predetermined distance between the object 34 and the vehicle 10. The object 34 forward of the vehicle 10 may be a bicycle, person, boat, trailer, automobile, or truck. The increase in the relative acceleration of the object 34 forward of the vehicle 10 may indicate that the object 34 is moving away from the vehicle 10. The anticipated amount of power may be greater than the power available from the powertrain while the powertrain is operating in EV mode and may start the engine 12 to provide additional power.

The controller 26 may operate the vehicle 10 in EV mode while the vehicle 10 is at a stop light, stop sign, or other situation where the vehicle is at rest and operational, and there is an object in front of the vehicle 10. While the vehicle 10 is operated in EV mode, the controller 26 may output a command to an electric pump to operate to maintain the fluid pressure from the brake booster/master cylinder to the wheel brakes 20. The electric pump may continuously operate to maintain the fluid pressure for significant periods of time. The engine start command may be sent by the controller 26 without or prior to the driver releasing the brake pedal 24 or depressing the accelerator pedal 22.

The controller 26 may not output an engine start command in various situations. For example, if there is sufficient electrical power to meet the anticipated power to maintain the predetermined distance between the object 34 forward of the vehicle 10, the vehicle 10 may continue to operate in EV mode and propel the vehicle 10 using electrical power. Alternatively, the driver may wish to creep the vehicle 10 by partially releasing the brake pedal 24. The controller 26 may continue to operate the vehicle 10 in EV mode and creep the vehicle 10 using electrical power.

The controller 26 may also output an engine shut down command in response to a decrease in relative acceleration of the object 34 forward of the vehicle 10 below a threshold. The decrease in the relative acceleration of the object 34 forward of the vehicle 10 may indicate that the object 34 is either moving towards the vehicle 10 or the vehicle 10 is moving towards the object 34 at a greater rate. The engine 12 may be commanded to shut down to reduce fuel consumption in anticipation of the driver demanding the vehicle 10 decelerate.

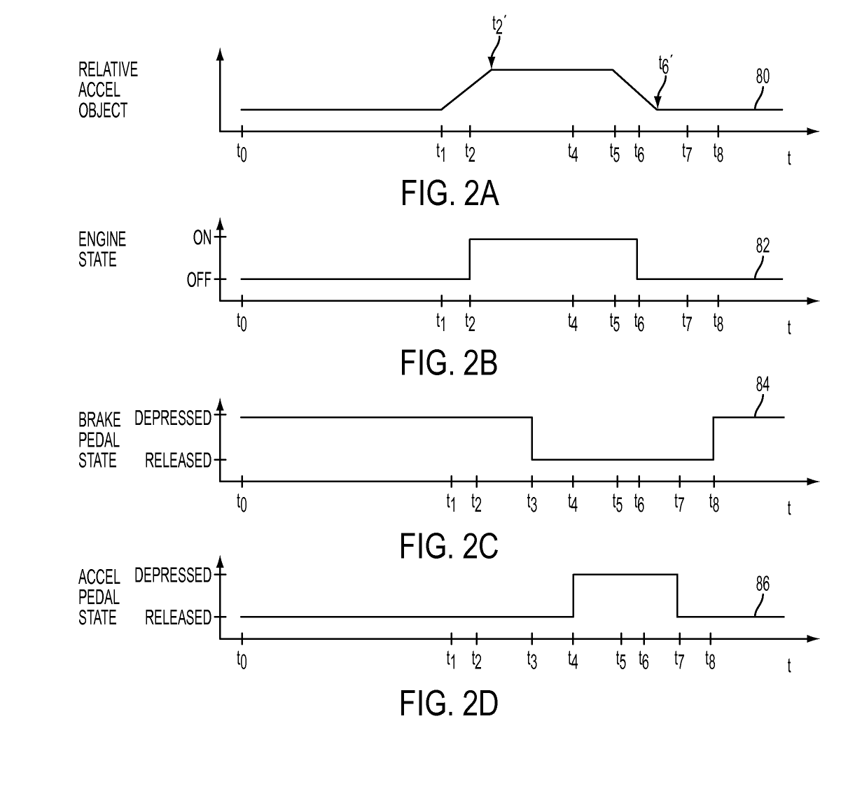

FIGS. 2A through 2D depict corresponding time plots of an exemplary system response to a change in relative acceleration of an object forward of the vehicle. Referring to FIG. 2A, a plot of the relative acceleration 80 of an object forward of the vehicle over time is shown. At t0, the relative acceleration between the vehicle and the object 34 forward of the vehicle may remain constant or within a threshold tolerance for relative acceleration. This constant relative acceleration between the vehicles may indicate that the vehicle and the object are stationary or traveling at similar speeds. At t1, the relative acceleration of an object forward of the vehicle may begin to increase. The increase in relative acceleration of the object forward of the vehicle may indicate that the object is moving away from the vehicle. At t2′, the relative acceleration of the object forward of the vehicle may become constant.

At t5, the relative acceleration of an object forward of the vehicle may begin to decrease. The decrease in the relative acceleration of the object forward of the vehicle may indicate that the object is slowing or approaching a stop relative to the vehicle. At t6′, the relative acceleration of the object forward of the vehicle may become constant.

Referring to FIG. 2B, a plot of the engine state 82 over time is shown. At t0, the engine state may indicate that the engine is off, meaning that the vehicle 10 may be operating in EV mode. At t2, as the relative acceleration of the object forward of the vehicle increases above a threshold, the engine may be started and the engine state may indicate that the engine is on. The powertrain 12 may then be operating in vehicle mode. At t6, as the relative acceleration of the object forward of the vehicle decreases below a threshold, the engine may be stopped. The engine state may indicate that the engine is off, meaning that the vehicle 10 may be operating in EV mode.

Referring to FIG. 2C, a plot of brake pedal state 84 over time is shown. At t0, the brake pedal state may indicate that the brake pedal is depressed and the brake pedal position remains generally constant. The driver may depress the brake pedal 24 while attempting to stop the vehicle or while the vehicle is stopped and on. The driver may release the brake pedal 24 beginning at t3. The brake pedal 24 may be released by the driver after the engine has been started at t2, in response to the relative acceleration of the object forward of the vehicle exceeding a threshold. The brake pedal 24 may remain released until t8, when the brake pedal 24 may be depressed by the driver. The driver may depress the brake pedal 24 to slow down or impede the movement of the vehicle 10 as it approaches the object forward of the vehicle. The driver may actuate the brake pedal 24 after the engine is stopped at t6.

Referring to FIG. 2D, a plot of accelerator pedal state 86 over time is shown. At t0, the accelerator pedal state may indicate that the accelerator pedal 22 is released. While the accelerator pedal 22 is released, the driver may have depressed the brake pedal 24 to restrict the vehicle 10 from creeping using electrical power. At t4, the driver may depress the accelerator pedal 22 to propel the vehicle, after the engine has been started at t2 and in response to the relative acceleration of the object forward of the vehicle exceeding a threshold. The accelerator pedal 22 may remain in the depressed state until t7, when the driver may release the accelerator pedal 22. The driver may release the accelerator pedal 22 to slow down the vehicle 10 as it approaches the object forward of the vehicle. The driver may release the accelerator pedal 22 after the engine is stopped at t6.

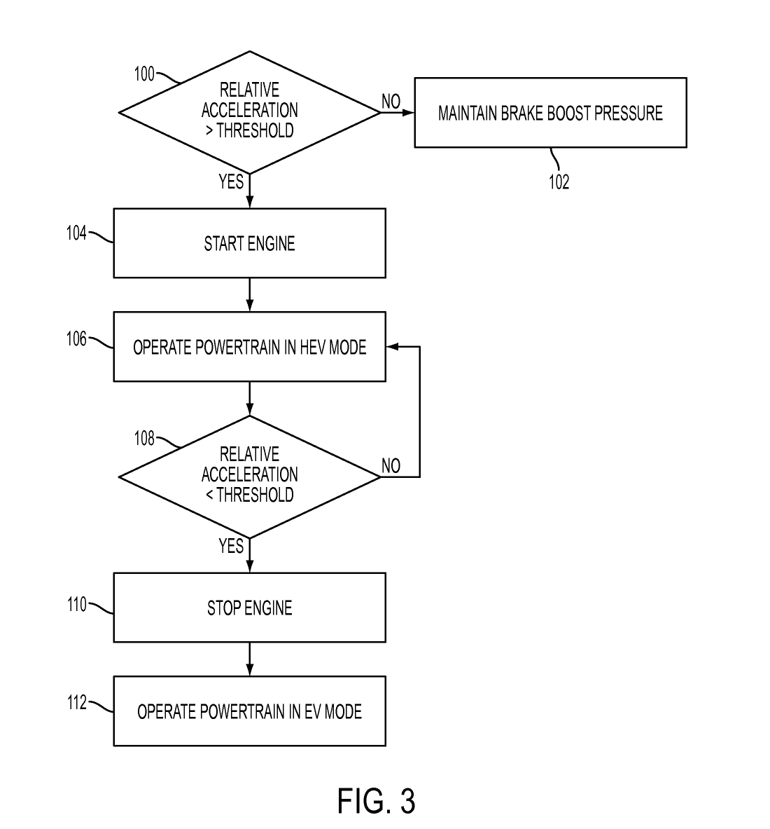

Referring to FIG. 3, a flowchart of a method of controlling a hybrid electric vehicle having an engine and an electric machine is shown. In at least one embodiment, the method may be executed by the controller 26 and may be implemented as a closed loop control system. For brevity, the method will be described within the context of a single iteration below.

At block 100, if the vehicle is operating in EV mode, the relative acceleration of the object forward of the vehicle may be compared to a threshold relative acceleration. This may include receiving a signal indicative of relative acceleration of the object from an object sensor or other device. The threshold relative acceleration may be a predetermined value such that a distance between the vehicle and the object in front of the vehicle is maintained. The threshold relative acceleration may also be determined based on traffic conditions such that a safe traveling distance between vehicles is maintained or the vehicle is not impeding the flow of traffic.

While operating the vehicle in EV mode, the engine may be off and the vehicle stopped. The method may maintain the brake booster pressure or master cylinder pressure at block 102 by operating an electric vacuum pump to continue applying the wheel brakes if the driver is depressing the brake pedal and/or the relative acceleration of the object is less than the threshold relative acceleration. The operation of the electric pump may permit the fluid pressure supplied to the wheel brakes to be maintained while the engine is off, without losing brake vacuum pressure.

At block 104, in response to an engine start command issued by the controller if the relative acceleration of the object forward of the vehicle exceeds a threshold, the engine may be started. The engine may be started in the absence of a change in accelerator pedal position or input, and/or in the absence of a change in brake pedal position. The controller may issue the engine start command if the available amount of electric power is less than an anticipated drive power to maintain a predetermined distance between the vehicle and the object forward of the vehicle. Upon starting the engine, the vehicle may begin operating in hybrid electric vehicle (HEV) mode, at block 106.

The method may continue to monitor the relative acceleration of the object forward of the vehicle at block 108. If the relative acceleration measured by the object sensor meets or exceeds a relative acceleration threshold, the powertrain may continue to operate in HEV mode. Should the relative acceleration of the object forward of the vehicle be less than a threshold relative acceleration, an engine stop command may be issued by the controller and the engine stopped, at block 110. The engine may be stopped in the absence of a change in accelerator pedal position and/or in the absence of a change in brake pedal position. Upon stopping the engine, the vehicle may begin operating in EV mode at block 112.

While exemplary embodiments are described above, it is not intended that these embodiments describe all possible forms of the invention. For example, the algorithm of FIG. 3 was described within the context of a hybrid electric vehicle. A similar algorithm may be used for a stop/start vehicle such that if the engine is auto-stopped and the detected relative acceleration exceeds a threshold, the engine is auto-started. And if the vehicle is stopping and the detected relative deceleration exceeds a threshold, the engine is auto-stopped. Other scenarios are also contemplated. The words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
an engine; and
at least one controller programmed to, while the engine is off and during a generally constant accelerator pedal input, start the engine in response to an increase in relative acceleration of an object in front of the vehicle greater than a threshold.

2. The vehicle of claim 1 wherein the controller is further programmed to operate an electric pump to maintain a brake booster pressure while the engine is off.

3. The vehicle of claim 1 wherein the controller is further programmed to start the engine in response to a brake pedal being depressed.

4. The vehicle of claim 1 wherein the controller is further programmed to, while the engine is on and during the generally constant accelerator pedal input, stop the engine in response to a decrease in relative acceleration of an object in front of the vehicle greater than another threshold.

5. The vehicle of claim 1 wherein the threshold is based on anticipated power to maintain a predetermined distance between the object and the vehicle.

6. A controller for a vehicle comprising:
communication channels configured to receive a relative acceleration signal and to provide a start/stop command for an engine; and
control logic configured to output via the communication channels a stop command for the engine, while the engine is on and during a generally constant accelerator pedal input, in response to the signal indicating a decrease in relative acceleration of an object in front of the vehicle greater than a threshold.

7. The controller of claim 6 wherein the control logic is further configured to output via the communication channels a start command for the engine, while the engine is off and during a generally constant accelerator pedal input, in response to the signal indicating an increase in relative acceleration of the object greater than another threshold.

8. The controller of claim 6 wherein the control logic is further configured to operate an electric pump to maintain a brake booster pressure while the engine is off.

9. The controller of claim 6 wherein the control logic is further configured to start the engine in an absence of a change in brake pedal position.

10. The controller of claim 6 wherein the threshold is based on anticipated power to propel the vehicle to maintain a predetermined distance between the object and the vehicle.

11. A method of controlling a hybrid electric vehicle having an engine and an electric machine comprising:
while operating in a first mode of operation with the engine off and a generally constant accelerator pedal input, starting the engine in response to an increase in relative acceleration of an object in front of the vehicle greater than a threshold.

12. The method of claim 11 further comprising operating an electric pump to maintain a brake booster pressure while operating in the first mode of operation.

13. The method of claim 11 further comprising starting the engine in an absence of a change in brake pedal position.

14. The method of claim 11 further comprising, while operating in a second mode of operation with the engine on and a generally constant accelerator pedal input, stopping the engine in response to a decrease in relative acceleration of an object in front of the vehicle greater than another threshold.

15. The method of claim 11 wherein the first mode of operation is an electric mode.

16. The method of claim 14 wherein the second mode of operation is a hybrid electric mode.
